(19) United States
(12) Patent Application Publication
(10) Pub. No.: US 2012/0211958 A1
(43) Pub. Date: Aug. 23, 2012

(54) METHOD AND APPARATUS FOR PRODUCING A STABILIZER BAR ASSEMBLY

(75) Inventor: Le Lam, Niagara Falls (CA)

(73) Assignee: H & L Tool and Die Ltd.

(21) Appl. No.: 13/032,328

(22) Filed: Feb. 22, 2011

(51) Int. Cl. B60G 21/055; B29C 65/70

(52) U.S. Cl. 280/124.106; 425/500

(57) ABSTRACT

A stabilizer bar assembly is disclosed and comprises a bar and a bushing. The bushing is adhesively secured to the bar, includes a body and two reinforcing members and has two wedge-shaped depressions formed therein, each defining a volume. The body is an elastomeric monolith surrounding the bar and the reinforcing members. The reinforcing members have parts protruding from the body and, in the absence of external forces, are held in an operative configuration fixedly positioned relative to the bar by the body. The depressions are shaped and dimensioned such that, if the monolith were absent, each volume was occupied in form-fitting relation by a respective rigid wedge element held against movement relative to the bar, and the protruding portions of the reinforcing members were gripped about their exteriors, the reinforcing members would be securely held in said operative configuration. Methods and apparatus for forming the assembly are also disclosed.

### FIELD OF THE INVENTION

This invention generally relates to vehicle stabilizer bar assemblies.

### BACKGROUND OF THE INVENTION

Stabilizer bar assemblies are well known as part of vehicle suspension systems. Conventional assemblies include a bar to which rubber bushings are mounted and brackets for securing the combination to an appropriate vehicle component. During normal operation, conventional arrangements tend to generate objectionable noise that results from rubbing action between the rubber bushings and the bar surface. It is also desirable to reinforce the rubber with steel, to improve mechanical properties. Various attempts have been made to address the foregoing. One proposed solution has been to mold a steel-reinforced rubber bushing to the bar in a manner which provides for adhesion therebetween. However, due to high cavity pressures, known techniques involve the use of retractable pins to hold the steel reinforcement during the molding process, which results in voids in the completed bushing that detract from durability.

### SUMMARY OF THE INVENTION

Forming one aspect of the invention is a stabilizer bar assembly comprising a bar and a bushing.

The bushing is adhesively secured to the outer surface of the bar, includes a body and one or more reinforcing members and has two or more wedge-shaped depressions formed therein, each depression defining a volume.

The body is an elastomeric annular monolith surrounding the bar and the reinforcing members.

The one or more reinforcing members have parts protruding from the body and, in the absence of external forces, are held in an operative configuration fixed in position relative to the bar by the body.

The depressions are shaped and dimensioned such that, if the elastomeric monolith were absent, each volume was occupied in form-fitting relation by a respective rigid wedge element held against movement relative to the bar, and the protruding portions of the reinforcing members were gripped about their exteriors, the one or more reinforcing members would be securely held in said operative configuration.

According to another aspect of the invention, the one or more reinforcing members can be plates.

According to another aspect of the invention, the one or more reinforcing members can consist of two reinforcing members.

According to another aspect of the invention, the one or more reinforcing members can consist of two arcuate plates disposed in opposed, spaced relation to one another and in substantially-surrounding, spaced relation to the bar.

According to another aspect of the invention, the elastomeric monolith can be rubber.

An improved apparatus for manufacturing a stabilizer bar assembly forms another aspect of the invention.

The stabilizer bar assembly is of the type including a bar and a bushing adhesively secured to an outer surface of the bar.

The bushing includes a body and one or more reinforcing members.

The body is an elastomeric annular monolith surrounding the bar and the reinforcing members and has an outer surface. The one or more reinforcing members, in the absence of external forces, are held in an operative configuration fixed in position relative to the bar by the body.

The apparatus is of the type including a mold including two or more mold parts, the two or more mold parts having a molding configuration whereat the two or inure mold parts: seal about the bar; define, in combination with the bar, a mold cavity in the shape of the bushing through which the bar passes; and securely hold said one or reinforcing members at least partially interiorly of the cavity and against movement.

The improvement comprises the two or more mold parts consisting of at least two mold parts each including at least one protuberance in the form of a wedge element.

The improvement further comprises the at least two mold parts and the reinforcing members being adapted such that, when the reinforcing members are positioned within a range of positions and the at least two mold parts are drawn together to the molding configuration, the reinforcing members are urged to the operative configuration by the at least two mold parts.

According to another aspect of the invention, the at least two mold parts can comprise a first part and a second part, each having a molding position defined by the molding configuration.

According to other aspects of the invention, the first part can also have a transport position and be movable between its molding position and its transport position; and the second part can also have a loading position for receiving the bar and the reinforcement members prior to molding and for removing of the stabilizer bar assembly following molding and be movable between its molding position and its loading position when the first part is in the transport position.

According to another aspect of the invention, each of the first and second parts can be heated in use such that when the first and second parts are in the molding configuration and the cavity defined thereby is filled with an elastomeric molding compound that is heat-curable into the elastomeric material, said elastomeric molding compound is cured into the body in a predetermined curing period.

According to another aspect of the invention, the at least two mold parts can comprise a first part and a pair of second parts.

According to another aspect of the invention, a heating element can be provided for each second part, each heating element being movable between a respective transport position, wherein the second part for which it provided can be moved between the loading position thereof and the molding position.

As well, when the second part is in the loading position thereof, the second part can be loaded with the bar and the reinforcement members prior to molding and can be relieved of the stabilizer bar assembly following molding; and a respective heating position.

According to other aspects of the invention, each heating element can be adapted such that, when the one of the second parts for which it is provided is in the loading position thereof and said each heating element is in the heating position, said each heating element and the one of the second parts heat the bar to a predetermined elastomeric molding compound-receiving temperature in a predetermined heating period.

As well, in use, the amount of time taken to remove a stabilizer bar assembly from a second part and load an empty second part with a bar and reinforcement members can be about equivalent to the difference between the predetermined curing period and the predetermined heating period.

Other advantages, features and characteristics of the method, will become more apparent upon consideration of the following detailed description and the appended claims.

### BRIEF DESCRIPTION OF THE DRAWINGS

FIG. 1 is a perspective schematic view showing manufacturing apparatus according to an exemplary embodiment of the invention;

FIG. 2 is a perspective view of a component set comprising a steel bar and a set of reinforcement plates used with the apparatus of FIG. 1;

FIG. 3 is a view of the structure of encircled area 3 of FIG. 1 in receipt of the steel bar of FIG. 2;

FIG. 4 is a view of encircled area 3 of FIG. 1 in receipt of the steel bar of FIG. 2 and in receipt of the structure of encircled area 4 of FIG. 1;

FIG. 5A is a view of the structure of encircled area 3 of FIG. 1 in the process of receiving the steel bar and the set of reinforcement plates of FIG. 2;

FIG. 5B is a view of the structure of encircled area 3 of FIG. 1 in receipt of the steel bar and the set of reinforcement plates of FIG. 2 and about to receive the structure of encircled area 5 of FIG. 1;

FIG. 5C is a view of the structure of encircled area 3 of FIG. 1 in receipt of the steel bar and the set of reinforcement plates of FIG. 2 and the structure of encircled area 5 of FIG. 1;

FIG. 5D is a partially exploded view of the structure of FIG. 5C;

FIG. 6 is a top plan view of encircled area 6 of FIG. 5C;

FIG. 7 is a view along section 7-7 of FIG. 6;

FIG. 8 is a perspective view of a portion of the structure of FIG. 5D;

FIG. 9 is a top plan view of the structure of FIG. 8;

FIG. 10 is a front view of the structure of FIG. 8; and

FIG. 11 is an enlarged view of encircled area 11 of FIG. 1.

### DETAILED DESCRIPTION

An exemplary method for manufacturing stabilizer bar assemblies is hereinafter described in detail.

### Apparatus

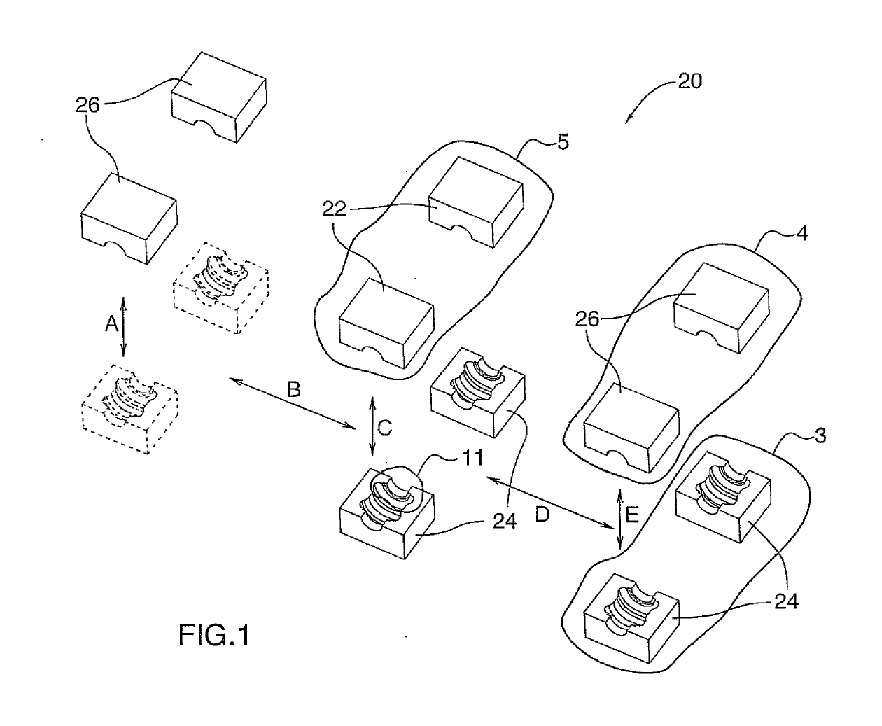

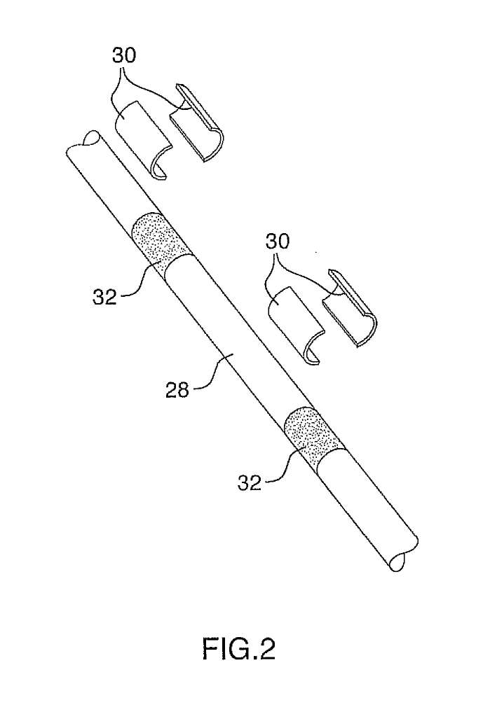

The exemplary manufacturing method contemplates a particular arrangement of apparatus 20 which is shown in schematic form in FIG. 1 and will be seen to include mold parts 22, 24 and heater elements 26. More specifically, the mold parts will be seen to comprise a first part 22 and a pair of second parts 24, and a heater element 26 will be seen to be provided for each second part 24. Each of the first part 22, second parts 24 and heater elements 26 will be seen in the illustrations to be a two-part structure, but it will be understood that each two-part structure could easily be formed in unitary fashion. Arrows A-E of FIG. 1 indicate that the parts 22, 24 and elements 26 are movable, as discussed in detail in following paragraphs, but for present purposes it should simply be understood that in FIG. 1, the first part 22 is shown in a transport position, each heater element 26 is shown in a respective transport position, one of the second parts 24 is shown in a loading position and the other of the second parts 24 is shown in a molding position; as well, a loading position of the one of the second parts 24 is indicated in phantom outline. The apparatus of FIG. 1 is for use with the component set of FIG. 2, which comprises a steel bar 28 and a set of reinforcement plates 30. The steel bar 28 has strips of adhesive 32 coated thereon, and the reinforcement members 30 take the form of arcuate steel plates. The areas of the bar 28 not covered with adhesive are painted, to resist corrosion in the finished part. The adhesive coating 32 is adapted to provide a strong, durable bond between steel and rubber, for reasons made evident below.

### Loading

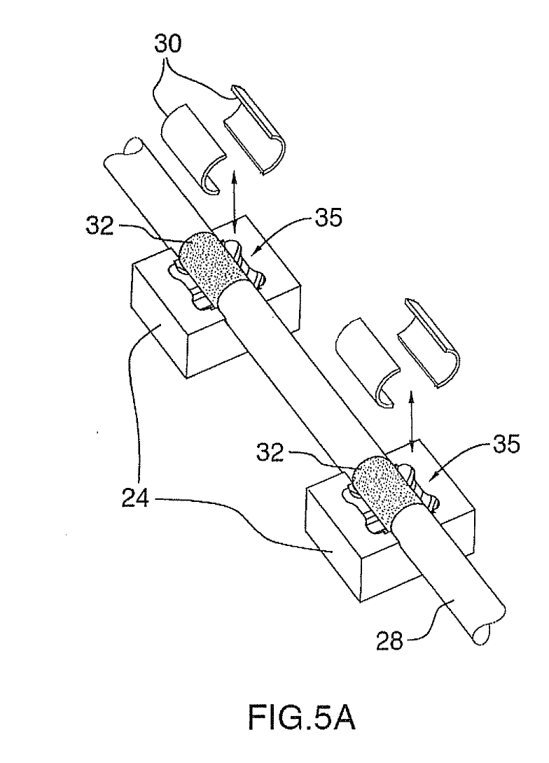

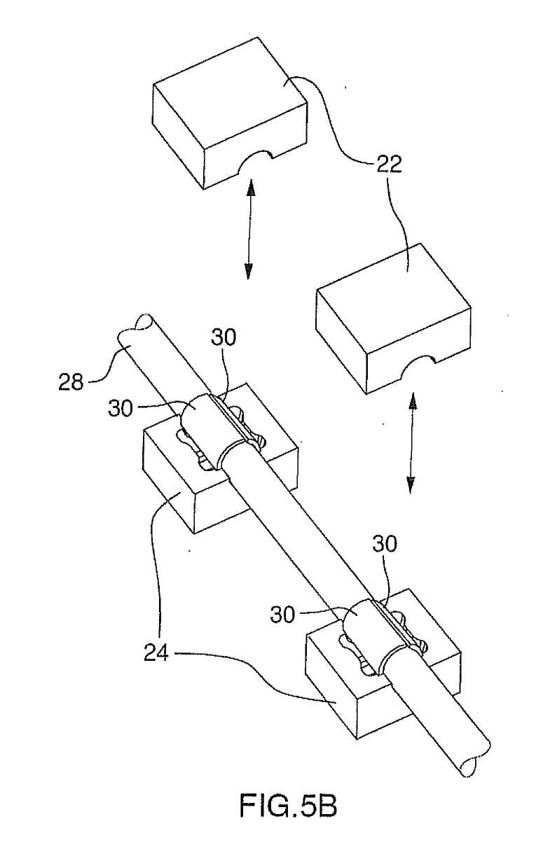

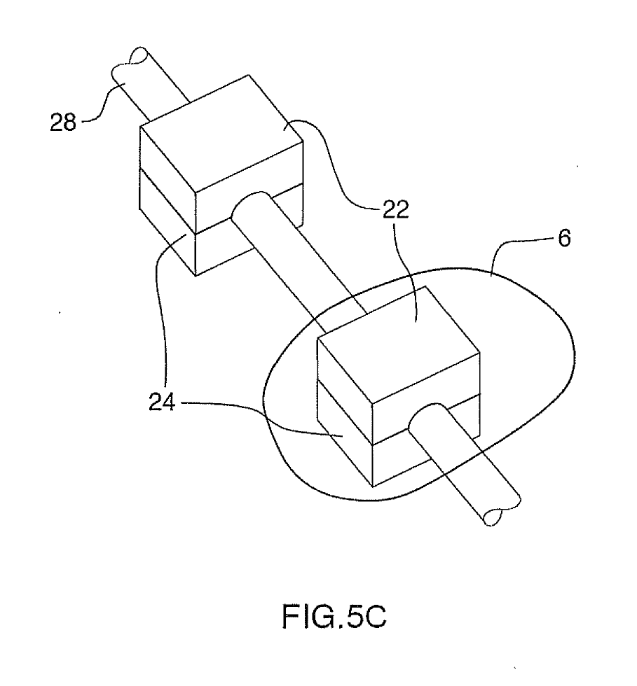

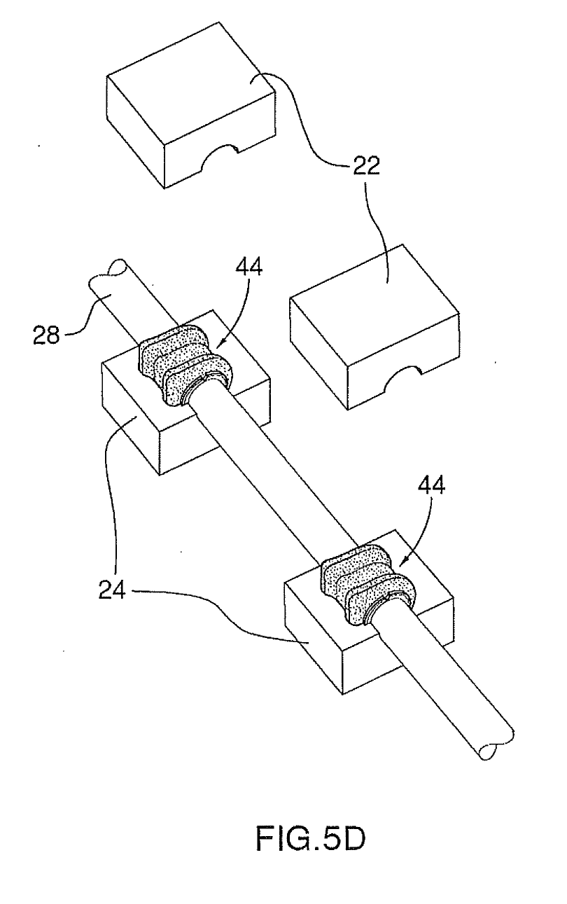

With regard to the loading positions of the second parts 24, it will be understood that when a second part 24 is in the loading position thereof, a bar 28 and reinforcement members 30 can be loaded therein, as shown by the sequence of FIGS. 5A, 5B. The adhesive coating 32 will be seen to be provided only in areas which, when assembled as shown in FIG. 5A, lie within the mold cavities 35. The second parts 24 will be understood to be heated in a conventional manner, i.e. with internal resistive heating, or conduits through which steam, hot oil or the like flows, such that placement of the bar 28 therein will commence a localized heating of the underside of the bar 28 and of the plates 30.

### Pre-heating

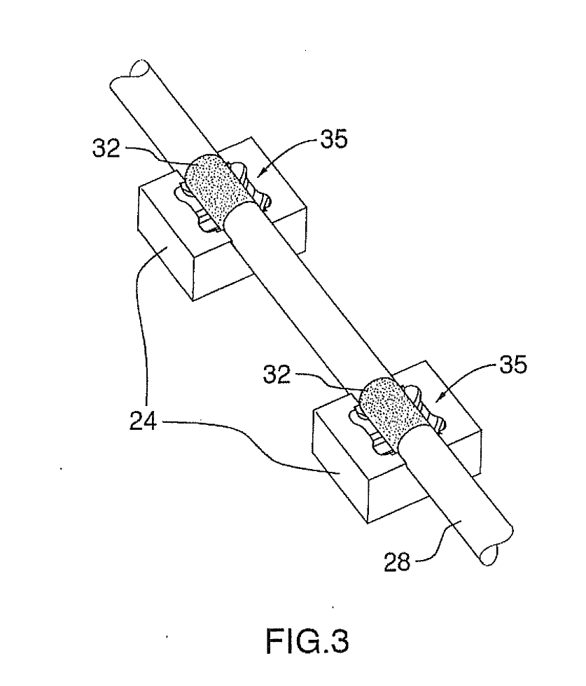

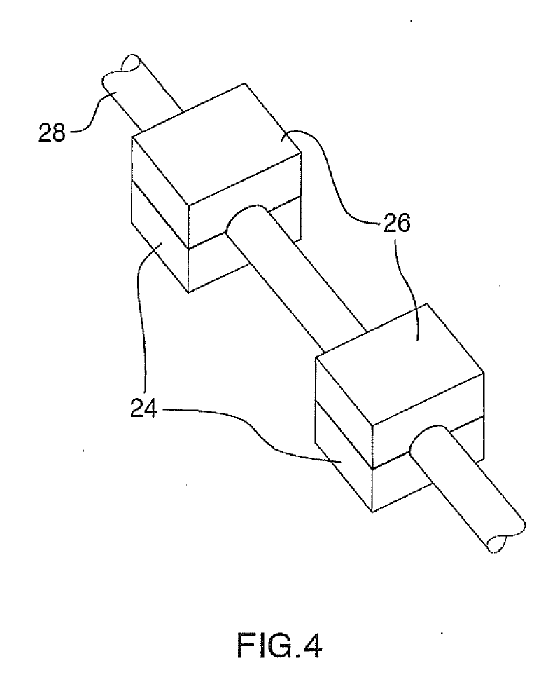

With the bar 28 loaded in a second mold part 24 as shown in FIG. 3, the heating element 26 provided for said second mold part 24 is moved from the transport position shown in FIG. 3 to the heating position shown in FIG. 4, whereat localized heating of the topside of the bar 28 commences. The heating element 26 is adapted such that, once in the heating position, the bar 28 is heated, in combination with the heated second mold part 24, to a predetermined elastomeric molding compound-receiving temperature in a predetermined period of time.

### Molding

With the bar 28 now heated to the appropriate temperature to receive elastomeric molding compound, the heating element 26 is moved back to the transport position, thereby to allow plates 30 to be loaded in the second mold part 24, i.e. as shown in FIG. 5A, and movement of the second part 24 to the molding position, i.e. to the platen of an injection molding machine (not shown). Thereafter, the first part 22, which is also heated in a conventional manner and operatively connected to the platen of the molding machine, is moved to its molding position, in abutment with the second part 24, as shown in FIGS. 5B, 5C.

This defines a molding configuration. In this configuration, the mold 22, 24 parts: seal about the bar 28; define, in combination with the bar 28, a mold cavity in the shape of a bushing and through which the bar 28 passes; and securely hold said reinforcing members 30 against movement.

This permits heat-curable rubber to be injected into the cavity in a conventional manner and heat-cured into an elastomeric rubber body in a predetermined curing period, as a result of the heat provided by the mold parts 22, 24.

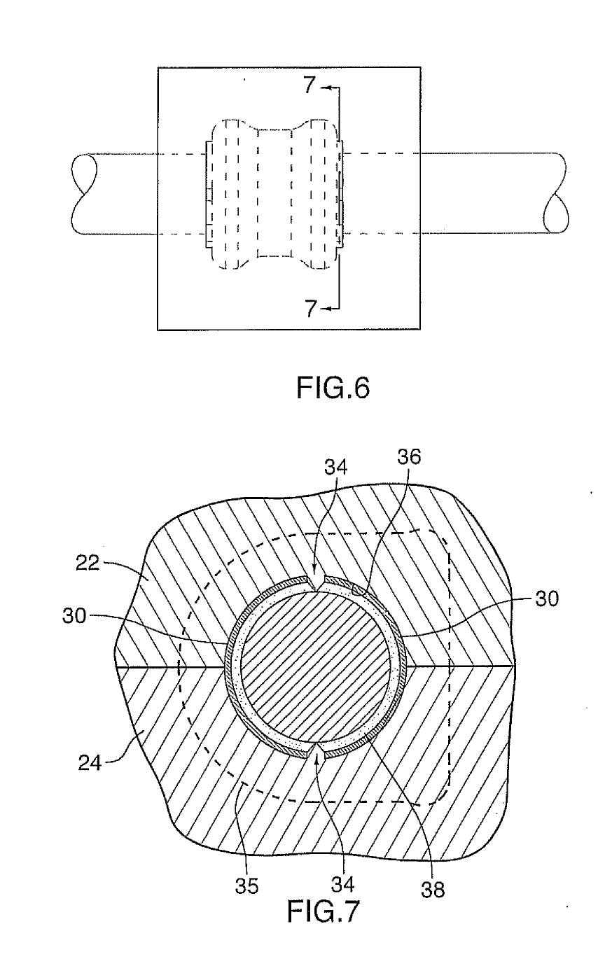

The manner in which the reinforcing members 30 are held against movement in the exemplary embodiment is evident from a review of FIG. 7. Herein, it will be seen that each of the first part 22 and the second part 24 includes a pair of protuberances in the form of a wedge element 34, and that the reinforcement plates 30 are securely held by interaction of the wedge elements 34 and the surface 36 of the mold cavity. Importantly, the arrangement will be understood to be self-fixturing, i.e., when the reinforcing members 30 are positioned within a range of positions, i.e. loosely fit as shown in FIG. 5B, and the at least two mold parts 22, 24 are drawn together to the molding configuration by the molding machine, the reinforcing members 30 are urged to the operative configuration shown in FIG. 7 by the at least two mold parts, i.e. by elements 24 and surface 36. For greater certainty, the elastomeric rubber body is visible in FIG. 7 and indicated by 38.

### Demolding

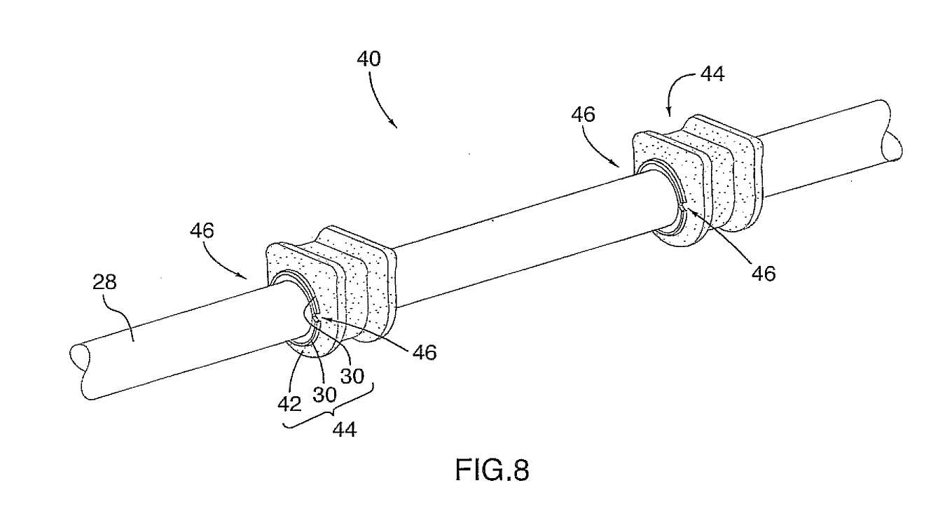

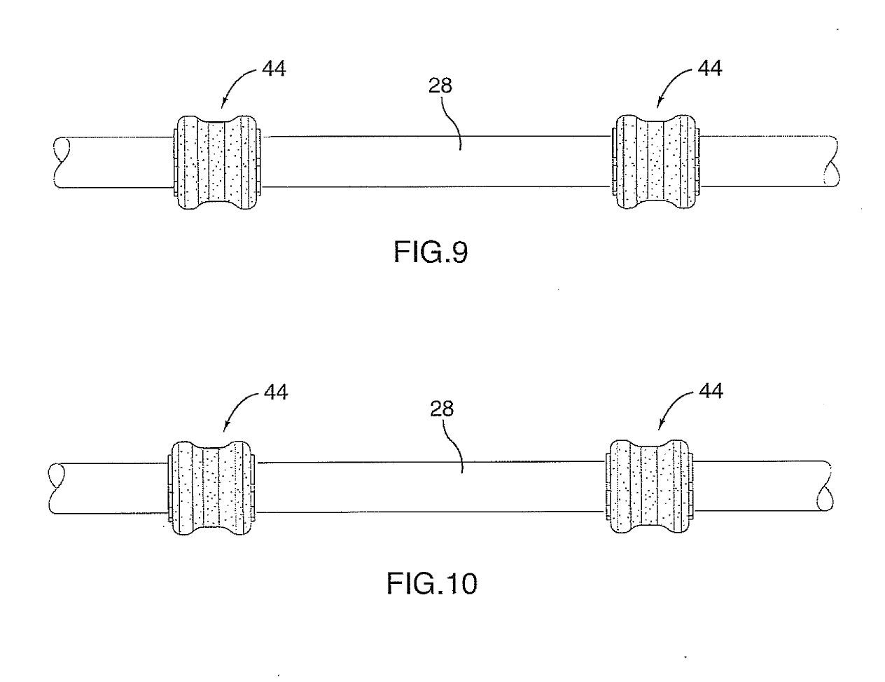

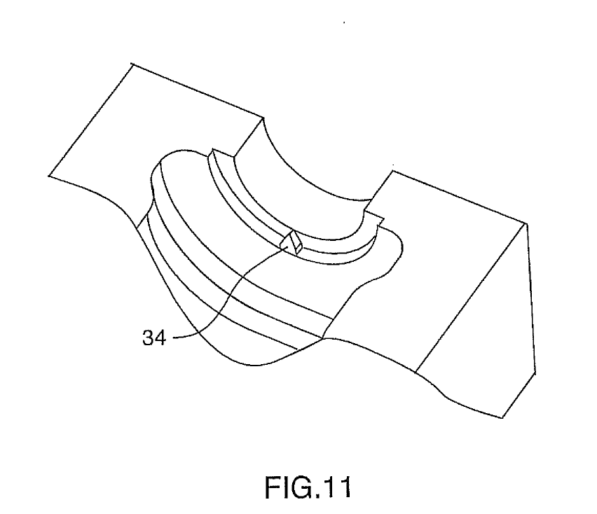

Once the rubber elastomeric molding compound has cured, the first mold part 22 returns to the transport position, as shown in FIG. 5B, thereby to allow the second mold part 24 to return to the loading position thereof, whereat the completed stabilizer bar assembly is removed and the process started anew; the completed bar assembly is shown in FIGS. 8-10 and indicated by reference numeral 40.

### Synchronization

As previously indicated, in the exemplary structure, a pair of second parts 24 are provided, along with a pair of heating elements 26. The apparatus 20 is advantageously adapted such that, in use, the amount of time taken to remove a completed stabilizer bar assembly 40 from a second part 24 and load an empty second part 24 with a bar 28 and reinforcement members 30 is about equivalent to the difference between the predetermined curing period and the predetermined heating period.

This permits maximum utilization of the molding machine, i.e. as soon as a predetermined curing period ends, the molding machine is opened [i.e. the first mold part 22 is moved to the transport position], the second mold part 24 containing the now-complete stabilizer bar 40 is moved to the loading position thereof, for part release and, simultaneously, the second mold part 24 carrying the now properly pre-heated bar 28 is brought into position to receive the first mold part 22 for a molding operation.

### Stabilizer Bar Assembly

With reference again to FIG. 8-10, the stabilizer bar assembly 40 obtained by the exemplary embodiment is of the general type including a bar 28 and a bushing 44 adhesively secured to an outer surface of the bar 28, the bushing including a body 42 and one or more reinforcing members 30, the body 42 being an elastomeric annular monolith surrounding the bar 28 and the reinforcing members 30, the one or more reinforcing members being, in the absence of external forces, held in an operative configuration fixed in position relative to the bar by the body.

However, the stabilizer bar assembly 40 of the present invention is characterized in that:
the one or more reinforcing members 30 have parts protruding from the body;
two or more wedge-shaped depressions 46 are formed in the bushing 44, each depression defining a volume;
the depressions 46 are shaped and dimensioned such that, if the elastomeric monolith 42 were absent, each volume was occupied in form-fitting relation by a respective rigid wedge element held against movement relative to the bar, and the protruding portions of the reinforcing members were gripped about their exteriors, the one or more reinforcing members would be securely held in said operative configuration.

Whereas but a single embodiment of the stabilizer bar assembly is illustrated and described, variations are, of course, possible.

For example, whereas the body is specified to be made from rubber, and the bar and plates from steel, other elastomers and materials can be used, and those skilled in the art who have the benefit of this description will be able to select the materials best suited to meet the needs of their particular situation.

As well, whereas the bar is specified to have an adhesive coating, this is not strictly necessary. Again, those skilled in the art who have the benefit of this description will be able to select the materials best suited to meet the needs of their particular situation.

Further, whereas a pair of second parts and a pair of heating elements are shown, this, of course, is not strictly necessary.

Accordingly, the invention should be understood as limited only by the accompanying claims, purposively construed.

1. A stabilizer bar assembly comprising:
a bar; and
a bushing adhesively secured to the outer surface of the bar, including a body and one or more reinforcing members and having two or more wedge-shaped depressions formed therein, each depression defining a volume;
the body being an elastomeric annular monolith surrounding the bar and the reinforcing members;
the one or more reinforcing members having parts protruding from the body and being, in the absence of external forces, held in an operative configuration fixed in position relative to the bar by the body; and
the depressions being shaped and dimensioned such that, if the elastomeric monolith were absent, each volume was occupied in form-fitting relation by a respective rigid wedge element held against movement relative to the bar, and the protruding portions of the reinforcing members were gripped about their exteriors, the one or more reinforcing members would be securely held in said operative configuration.

2. A stabilizer bar assembly according to claim 1, wherein the one or more reinforcing members are plates.

3. A stabilizer bar assembly according to claim 1, wherein the one or more reinforcing members consist of two reinforcing members.

4. A stabilizer bar assembly according to claim 1, wherein the one or more reinforcing members consist of two arcuate plates disposed in opposed, spaced relation to one another and in substantially-surrounding, spaced relation to the bar.

5. A stabilizer bar assembly according to claim 1, wherein the elastomeric monolith is rubber.

6. An improved apparatus for manufacturing a stabilizer bar assembly,
the stabilizer bar assembly being of the type including a bar and a bushing adhesively secured to an outer surface of the bar, the bushing including a body and one or more reinforcing members, the body being an elastomeric annular monolith surrounding the bar and the reinforcing members and having an outer surface, the one or more reinforcing members being, in the absence of external forces, held in an operative configuration fixed in position relative to the bar by the body,
the apparatus being of the type including a mold including two or more mold parts, the two or more mold parts having a molding configuration whereat the two or more mold parts: seal about the bar; define, in combination with the bar, a mold cavity in the shape of the bushing through which the bar passes; and securely hold said one or reinforcing members at least partially interiorly of the cavity and against movement,
the improvement comprising: the two or more mold parts consists of at least two mold parts each including at least one protuberance in the form of a wedge element; and the at least two mold parts and the reinforcing members being adapted such that, when the reinforcing members are positioned within a range of positions and the at least two mold parts are drawn together to the molding configuration, the reinforcing members are urged to the operative configuration by the at least two mold parts.

7. Apparatus according to claim 6, wherein the at least two mold parts comprise a first part and a second part, each having a molding position defined by the molding configuration.

8. Apparatus according to claim 7, wherein:
the first part also has a transport position and is movable between its molding position and its transport position; and
the second part also has a loading position for receiving the bar and the reinforcement members prior to molding and for removing of the stabilizer bar assembly following molding and is movable between its molding position and its loading position when the first part is in the transport position.

9. Apparatus according to claim 8, wherein each of the first and second parts are heated in use such that when the first and second parts are in the molding configuration and the cavity defined thereby is filled with a elastomeric molding compound that is heat-curable into the elastomeric material, said elastomeric molding compound is cured into the body in a predetermined curing period.

10. Apparatus according to claim 9, wherein the at least two mold parts comprise a first part and a pair of second parts.

11. Apparatus according to claim 10, further comprising a heating element for each second part, each heating element being movable between
a respective transport position, wherein the second part for which it provided can be moved between the loading position thereof and the molding position, and wherein, when the second part is in the loading position thereof, the second part can be loaded with the bar and the reinforcement members prior to molding and can be relieved of the stabilizer bar assembly following molding; and
a respective heating position.

12. Apparatus according to claim 11, wherein each heating element is adapted such that, when the one of the second parts for which it is provided is in the loading position thereof and said each heating element is in the heating position, said each heating element and the one of the second parts heat the bar to a predetermined elastomeric molding compound-receiving temperature in a predetermined heating period.

13. Apparatus according to claim 12, wherein, in use, the amount of time taken to remove a stabilizer bar assembly from a second part and load an empty second part with a bar and reinforcement members is about equivalent to the difference between the predetermined curing period and the predetermined heating period.
